(19) United States
(12) Patent Application Publication
(10) Pub. No.: US 2008/0077277 A1
(43) Pub. Date: Mar. 27, 2008

(54) APPARATUS AND METHOD FOR EXPRESSING EMOTIONS IN INTELLIGENT ROBOT BY USING STATE INFORMATION

(76) Inventors: Cheon Shu PARK, Daejeon (KR); Joung Woo RYU, Goyang-si (KR); Joo Chan SOHN, Daejeon (KR); Young Jo CHO, Seongnam (KR)

Correspondence Address: LADAS & PARRY LLP, 224 SOUTH MICHIGAN AVENUE, SUITE 1600, CHICAGO, IL, 60604, US

(21) Appl. No.: 11/846,010

(22) Filed: Aug. 28, 2007

(30) Foreign Application Priority Data
Sep. 26, 2006 (KR) 10-2006-0093538

(51) Int. Cl. B25J 9/00; B25J 19/02

(52) U.S. Cl. 700/245; 901/46

(57) ABSTRACT

An apparatus and method for expressing emotions in an intelligent robot. In the apparatus, a plurality of different sensors sense information about internal/external stimuli. A state information collector processes the detected information about the internal/external stimuli in a hierarchical structure to collect external state information. An emotion motive determiner determines an emotion need motive on the basis of the external state information and the degree of a change in an emotion need parameter corresponding to internal state information. An emotion state manager extracts available means information for satisfaction of the generated emotion needs motive and state information corresponding to the available means information. An emotion generator generates emotion information on the basis of a feature value of the extracted state information. An action determiner determines action information for satisfaction of the emotion need motive on the basis of the extracted state information and the generated emotion information. An action expresser expresses an action corresponding to the action information through a corresponding actuator on the basis of the determined action information.

### CLAIM OF PRIORITY

This application claims the benefit of Korean Patent Application No. 2006-93538 filed on Sep. 26, 2006 in the Korean Intellectual Property Office, the disclosure of which is incorporated herein by reference.

### BACKGROUND OF THE INVENTION

1. Field of the Invention

The present invention relates to intelligent robots and, more particularly, to an apparatus and method for expressing an emotion in an intelligent robot, which can express a specific emotion of the intelligent robot in the form recognizable by a user so that an emotional communication between the user and the intelligent robot is possible through touch.

2. Description of the Related Art

Recently, researches are being actively conducted to develop robots that can help a user to do a desired job so as to accommodate the convenience of the user. Special interests are being taken to develop an intelligent robot that can make an intelligent determination through an interaction with a user and can perform a corresponding operation.

Technologies are being developed to provide an intelligent with a function for generating a corresponding emotion in accordance with a predefined condition and expressing a corresponding action on the basis of simple external sensor information. In addition, researches are being actively conducted to develop an intelligent robot that can interact with a user by detecting the emotional state of the user through an image taken by a camera and reflecting the detected emotional state in creation of an emotion.

However, such a conventional method, in which a human emotion is detected by recognition of a human image or by recognition of the strength, tempo and tone of a human voice, has a limit in terms of accuracy. A conventional emotion expression method mainly uses a human face, but emotion expression technologies using other body portion is unsatisfactory as yet.

The conventional technologies merely provide an emotion expression means where a human face is mainly used and different emotion models and action expression models exist in respective platforms, which is unsatisfactory in providing an emotional communication with humans by touch with the humans. Typical examples of researches for emotion expression technologies using a facial expression are “Kismet” of MIT (Massachusetts Institute of Technology), “WE-4RII” of Waseda University, and “Icat” of Philips Corporation. “AIBO” of Sony Corporation is a pet-type robot that can control natural actions like those of a living thing so as to express emotions. These emotion expression technologies express emotions by simply calculating the degrees of good feeling and bad feeling on the basis of object information that is detected through a cognitive model that is trained using external information of vision, voice and touch sensors, which have a limit in expressing a variety of emotions depending on conditions.

In addition, the conventional emotion expression technologies using an intelligent robot focus on a method for controlling an action of the robot on the basis of an emotion model. That is, the conventional emotion expression technologies for an intelligent robot merely estimate a signal from a combination of single sensors without providing a method for processing signals received from a variety of sensors.

Recently, various sensors are being developed to provide a robot similar to a living thing. Specifically, MIT is conducting a “Huggable” project for installing a “sensitive skin” on the entire body of an intelligent robot to provide a more natural interaction with the human being.

What is therefore required are a method for processing information that is collected through various sensors in an intelligent robot, a method for determining an emotion, and a method for expressing a corresponding action.

### SUMMARY OF THE INVENTION

The present invention has been made to solve the foregoing problems of the prior art and therefore an aspect of the present invention is to provide an apparatus and method for expressing an emotion in an intelligent robot, which makes it possible to express a corresponding action more accurately in response to the current emotion state of the intelligent robot.

Another aspect of the invention is to provide an apparatus and method for expressing an emotion in an intelligent robot, which makes it possible to express an action in accordance with a more accurate emotion of the intelligent robot by collecting a variety of information factors for expression of emotions.

A further aspect of the invention is to provide an apparatus and method for expressing an emotion in an intelligent robot, which makes it possible to express a suitable action for satisfaction of the needs thereof on the basis of the internal/external emotional states of the intelligent robot.

According to an aspect of the invention, an apparatus for expressing emotions in an intelligent robot includes: a plurality of different sensors for sensing information about internal/external stimuli; a state information collector for processing the detected information about the internal/external stimuli in a hierarchical structure to collect external state information; an emotion motive determiner for determining an emotion needs motive on the basis of the external state information and the degree of a change in an emotion need parameter corresponding to internal state information; an emotion state manager for extracting available means information for satisfaction of the generated emotion needs motive and state information corresponding to the available means information; an emotion generator for generating emotion information on the basis of a feature value of the extracted state information; an action determiner for determining action information for satisfaction of the emotion need motive on the basis of the extracted state information and the generated emotion information; and an action expresser for expressing an action corresponding to the action information through a corresponding actuator on the basis of the determined action information.

According to an embodiment of the invention, the state information collector includes at least one first-order state node disposed in a first-order state layer of the hierarchical structure, the first-order state node merging desired information out of internal/external stimulus information to extract one or more first-order state item. The state information collector further includes at least one second-order state node disposed in a second-order state layer higher than the first-order state layer, the second-order state node merging the second-order state items from the first-order state node to extract a second-order state item.

According to another embodiment of the invention, the emotion state manager includes: an emotion factor manager for generating and managing emotion factors with respect to the external state information collected by the state information collector and the emotion need motive information determined by the emotion motive determiner, by using a preset emotion mapping table; an emotion feature generator for generating an emotion feature value for determination of an emotion for the external state information and the emotion need motive information on the basis of the generated emotion factor; and a means availability estimator for estimating the availability of a means for satisfaction of the emotion motive determined by the emotion motive determiner on the basis of the emotion feature value to extract available means information for satisfaction of the emotion need motive and state information corresponding to the available means information.

According to another aspect of the invention, a method for expressing emotions in an intelligent robot includes: sensing information about internal/external stimuli using a plurality of sensors; processing the detected information about the internal/external stimuli in a hierarchical structure to collect external state information; determining an emotion need motive on the basis of the external state information and the degree of a change in an emotion need parameter corresponding to internal state information; extracting available means information for satisfaction of the generated emotion need motive and state information corresponding to the available means information; generating emotion information on the basis of a feature value of the extracted state information; determining action information for satisfaction of the emotion need motive on the basis of the extracted state information and the generated emotion information; and expressing an action corresponding to the action information through a corresponding actuator on the basis of the determined action information.

According to certain or exemplary embodiments of the invention, a variety of sensors are attached to the corresponding parts of the intelligent robot and sensor values are processed in a hierarchical structure to obtain a variety of external state information, which cannot be obtained from a single sensor, thereby making it possible to predict the accurate state of the intelligent robot. In addition, an emotion is calculated using a weight change in state information with time, thereby making it possible to generate a new emotion in an indirect consideration of the previously-generated emotion. This enables the intelligent robot to express an emotion action related with the previous action, thereby making it possible to express an emotion more accurately and naturally.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram of an apparatus for expressing emotions in an intelligent robot by using emotional states generated in response to internal/external stimuli, according to an embodiment of the present invention;

FIG. 2 is a block diagram illustrating a hierarchical structure of internal/external sensors and a state information collector, according to an embodiment of the present invention;

FIG. 3 is a graph illustrating an example of need-based emotion motive determination in which an emotion motive determiner determines a motive for an emotion through an internal stimulus;

FIG. 4 is a detailed block diagram of an emotion state manager of FIG. 1 according to an embodiment of the present invention.

FIG. 5 is a diagram illustrating an example of a method for calculating, at an emotion feature generator, an active emotion feature value “Actuation E_{A}” using the weight of a state item that is an emotion factor that varies with a predetermined time.

FIG. 6 is a diagram illustrating a process for estimating, at a means availability estimator, the availability of a means that is available as a decision model for a means for satisfying a motive, according to an embodiment of the present invention;

FIG. 7 is a flowchart illustrating a method for generating and expressing emotions on the basis of information about the internal/external stimuli of in the intelligent robot according to an embodiment of the present invention; and

FIG. 8 is a flowchart illustrating in detail the emotion estimation, the emotion generation and the emotional action expression using the state information of the intelligent robot that is generated in response to the external/internal stimuli as illustrated in FIG. 7.

### DETAILED DESCRIPTION OF THE PREFERRED EMBODIMENT

Certain or exemplary embodiments of the present invention will now be described in detail with reference to the accompanying drawings.

In the following description of the embodiments of the present invention, detailed descriptions about well-known functions and configurations incorporated herein will be omitted if they are deemed to obscure the subject matter of the present invention. In addition, like reference numerals in the drawings denote like elements.

The present invention is intended to provide an apparatus and method for expressing an emotion in an intelligent robot. In the apparatus and method, a variety of information, which is collected through a variety of internal/external sensors of the intelligent robot, is used to detect a more delicate and accurate emotion and thus to express a corresponding action for satisfaction of a corresponding need. In the apparatus and method, the internal/external sensor information of the intelligent robot is merged into the hierarchy structure of separate sensors to generate the complex information about the current state of the intelligent robot and to generate a need-based emotion motive for a stimulus. An emotion and an available means for satisfaction of a generated emotion motive are estimated to generate the most suitable emotion, thereby expressing an action for satisfaction of the generated emotion.

That is, the present invention is intended to overcome the problems of the convention method in which information about a signal sensor or information about a combination of plural single sensors is collected. In the present invention, a variety of sensors are attached to various parts of the intelligent robot to process sensor values in a hierarchical structure. Accordingly, complex state information, which cannot be obtained from a single sensor, is generated to make it possible to detect the state of the intelligent robot more accurately. In addition, the present invention makes it possible to express an action for an emotion that is suitable for the current state of the intelligent robot, through collection of the state information about the intelligent robot, determination of an emotional motive, and satisfaction of the emotional motive. That is, the need and the internal/external states of the intelligent robot are used to generate an emotion motive, thereby generating a motive that is suitable for the current state of the intelligent robot. The emotion state information (external state information, emotional states, and emotional need motive) of the intelligent robot is used to generate an emotion for satisfaction of an emotion motive. By estimation of the availability of a means that is currently supportable by the intelligent robot, a suitable action expression is provided as a means for expression of an emotion for satisfaction of a motive.

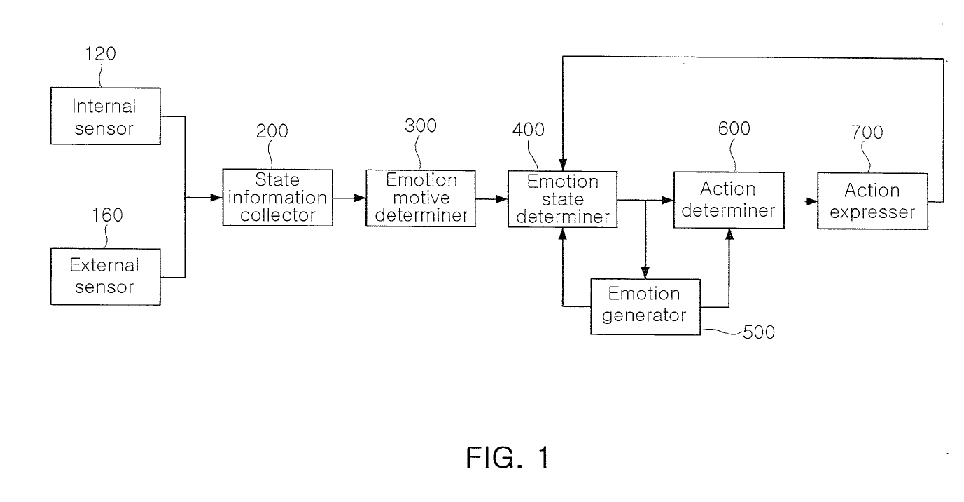

FIG. 1 is a block diagram of an apparatus for expressing emotions in an intelligent robot by using emotional states generated in response to internal/external stimuli, according to an embodiment of the present invention.

Referring to FIG. 1, the expression expressing apparatus includes an internal sensor 120, an external sensor 160, a state information collector 200, an emotion motive determiner 300, an emotion state manager 400, an emotion generator 500, an action determiner 600, and an action expresser 700.

The internal sensor 120 senses internal stimulus information, which is generated due to the internal environments of the intelligent robot, and provides the internal stimulus information to the state information collector 200. Examples of the internal stimulus information are information about internal temperature and information about battery capacity necessary for the operation of the intelligent robot.

The external sensor 160 senses external stimulus information, which is generated due to the external environments of the intelligent robot, and provides the external stimulus information to the state information collector 200. Examples of the external stimulus information are touch, vision, and audition.

The state information collector 200 collects current state information about the intelligent robot by using the internal stimulus information and the external stimulus information received respectively from the internal sensor 120 and the external sensor 160. The state information collector 200 provides the current state information about the intelligent robot to the emotion motive collector 200.

The emotional motive determiner 300 determines the motive of a corresponding emotion on the basis of the current state information about the intelligent robot that is received from the state information collector 200. That is, the emotional motive determiner 300 determines an emotional motive according to the level of satisfaction with a need-based need parameter, which is based on the internal stimulus information received from the internal sensor 120, and with a state-information-based emotion parameter, which is based on the external stimulus information received from the external sensor 160.

The emotion state manager 400 provides the action determiner 600 with a means available for expressing the emotional need, which is generated as a result of the determination of the emotion motive determiner 300, and the corresponding emotion state information. In addition, the emotion state manager 400 stores and manages the external state information, the internal state information, the emotion state information and the action state information about the intelligent robot. Furthermore, using the state information (e.g., emotion state information, emotion need motive information, and external state information) of the intelligent robot, the emotion state manager 400 generates an emotion feature value for an emotion model axis on a three-dimensional emotion vector space and determines a current emotion state.

The emotion generator 500 maps the emotion feature value, which corresponds to the emotion state information determined by the emotion state manager 400, into a three-dimensional emotion space (Activation, Pleasantness, and certainty) of an emotion model to perform an emotion evaluation, thereby generating a suitable emotion.

The action determiner 600 determines the final action to be expressed for satisfaction of the emotional need, on the basis of the information about the means for expressing the emotional need, which is received from the emotion state manager 400, the optimal emotion state information corresponding thereto, and the means information about the emotion state information corresponding to the emotion generated by the emotion generator 500.

The action expresser 700 actually expresses a suitable action that corresponds to the final action determined by the action determiner 600.

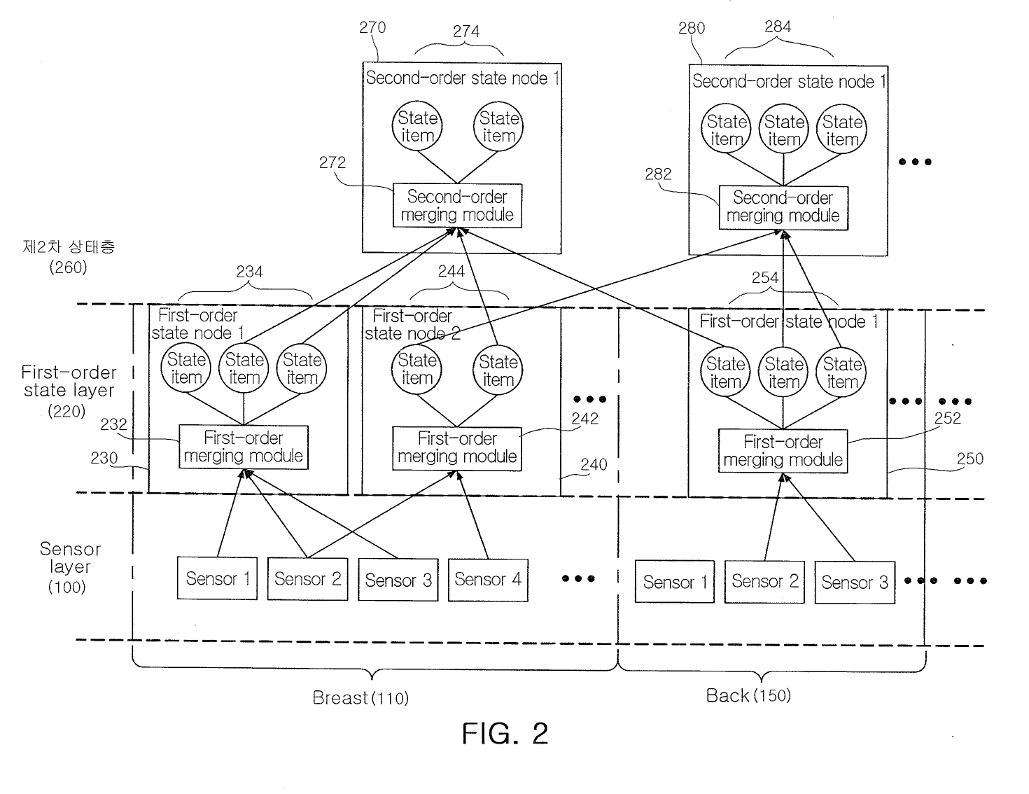

FIG. 2 is a block diagram illustrating a hierarchical structure of the internal/external sensors 120 and 160 and the state information collector 200, according to an embodiment of the present invention.

The external stimulus information generated by the state information collector 200 is information for indicating the current state of the intelligent robot that can be known by external stimuli. Examples of the external stimulus information are the state of a moving body of the intelligent robot, the state of contact with an object, and peripheral states such as the emotional state of a user, peripheral brightness, and a distance from an object. For example, there is a case of “I feel hot and hungry, but someone is embracing me and I am closing my eyes with my head leaned.” “Someone is embracing me and I am closing my eyes with my head leaned” corresponds to the external state information of the intelligent robot. “I feel hot and hungry” corresponds to the external state information of the intelligent robot, which is determined by the emotion motive determiner 300.

Referring to FIG. 2, the hierarchical structure of the internal/external sensors 120 and 160 and the state information collector 200 for hierarchical signal processing includes a sensor layer 100; a first-order state layer 220; and a second-order state layer 260. The sensor layer 100 is created by the internal sensor 120 and the second sensor 160. The first-order state layer 220 and the second-order state layer 260 are created by the state information collector 200.

In general, the higher a layer is, it is possible to extract a variety of complex external state information that cannot be detected by a single sensor. However, as the number of layers increases, highly-uncertain information elements are merged together. In this case, accurate external state information for determination of the current state is difficult to generate, and the corresponding structure becomes complicated. Accordingly, in order to extract complex state items from information sensed by the internal/external sensors 120 and 160, the state information collector 200 is configured to include two layers (i.e., the first-order state layer and the second-order state layer).

The sensor layer 100 includes sensors that can sense internal stimuli and external stimuli. Examples of the sensors of the sensor layer 100 are visual sensors, speech sensors, illumination sensors, distance sensors, touch sensors, thermal sensors, temperature sensors, acceleration sensors, vibration sensors, and battery sensors.

For example, the touch sensors are installed at different parts of the intelligent robot to sense different stimuli for the corresponding parts of the intelligent robot, and a sensor node of the sensor layer 100 and a state node of the first-order state layer 220 are defined for each part of the intelligent robot to discriminate between the different stimuli for the corresponding parts of the intelligent robot. For example, in the condition of the intelligent robot, such as “Someone is embracing me and I am closing my eyes with my head leaned”, different stimuli are sensed by touch sensors that are installed respectively at the back, breast and head of the intelligent robot sense.

The first-order state layer 220 includes state nodes 230, 240 and 250, and the second-order state layer 260 includes state nodes 270 and 280. The state nodes 230, 240, 250, 270 and 280 merge input values to generate one or more state items 234, 244, 254, 274 and 284 with a degree of belief. Values input to the state nodes 230, 240 and 250 of the first-order state layer 220 are stimulus information that are sensed by sensors attached to the specific parts (e.g., a breast part 110 and a back part 150) of the intelligent robot. Values input to the state nodes 270 and 280 of the second-order state layer 260 are the degree of belief of the state items 234, 244 and 254 that are extracted by the state nodes 230, 240 and 250 of the first-order state layer 220. The degree of belief indicates the accuracy of the state items in the current state of the intelligent robot and has a value of [0,1]. Accordingly, in the present invention, the external sate information is defined as a set of state items with a predetermined degree of belief or more.

The state node 230 of the first-order state layer 220 has a first-order merging module 232 that receives and merges stimulus information sensed by the corresponding sensors and then extracts and outputs a plurality of corresponding state items. The state node 240 of the first-order state layer 240 has a first-order merging module 242 that receives and merges stimulus information sensed by the corresponding sensors and then extracts and outputs a plurality of corresponding state items. The state node 250 of the first-order state layer 220 has a first-order merging module 252 that receives and merges stimulus information sensed by the corresponding sensors and then extracts and outputs a plurality of corresponding state items. The state node 270 of the second-order state layer 260 has a second-order merging module 272 that receives and merges some of the state items 234, 244 and 254 from the state nodes 230, 240 and 250 of the first-order state layer 220 and extracts a plurality of corresponding state items. The state node 280 of the second-order state layer 260 has a second-order merging module 282 that receives and merges some of the state items 234, 244 and 254 from the state nodes 230, 240 and 250 of the first-order state layer 220 and extracts a plurality of corresponding state items.

In the present embodiment, the state items extracted by the state nodes 230, 240, 250, 270 and 280 are predefined in accordance with the state to be indicated by the corresponding node. The merging module (232, 242, 252, 272, 282) of the corresponding node is determined according to a defined input/output value. The merging modules 232, 242, 252, 272 and 282 may use any merging scheme that uses a weighted average, a fuzzy decision tree, a neural network, or a Dempster-Shaffer theory.

For example, in the current condition of the intelligent robot such as “Someone is embracing me”, the external state information is “Someone” and “is embracing”. The “Someone” state item is generated as the state items 234, 244 and 254 at the first-order state nodes of the first-order state layer 220 that receives the output values of a thermal sensor and a touch sensor that are installed at the breast part 110 and the back part 150. The “is embracing” state item is generated as the state item 274 or 284 at the state node 270 or 280 of the second-order state layer 260 by merging the degrees of belief about a “take” state item that is generated at the state nodes 230 and 240 of the breast part 110 in the first-order stage layer 220 and a “take” state item that is generated at the state node 250 of the back part 150 in the first-order state layer 220.

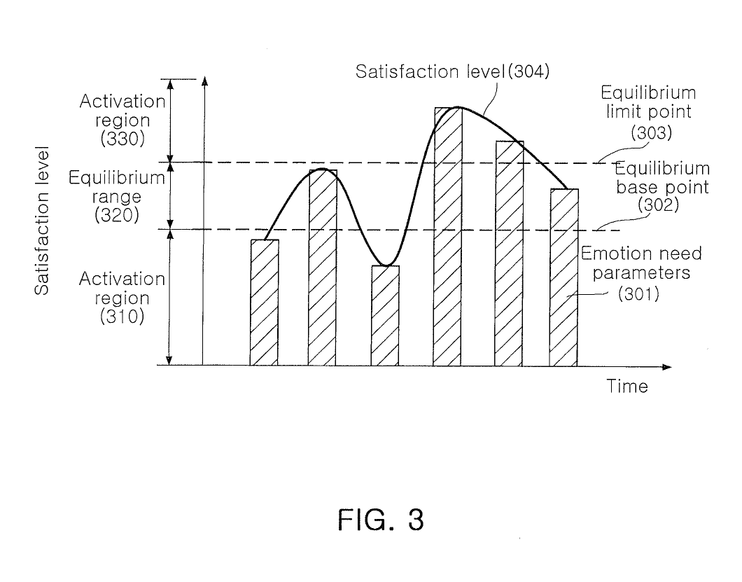

FIG. 3 is a graph illustrating an example of need-based emotion motive determination in which the emotion motive determiner 300 determines a motive for an emotion through an internal stimulus.

The emotion motive determiner 300 uses two methods to determine an emotional motive. In the first method, the emotion motive determiner 300 determines an emotional motive on the basis of emotion parameters for managing external stimulus information using the state information of the intelligent robot with respect to an external stimulus. In the second method, the emotion motive determiner 300 determines an emotional motive on the basis of need-bases need parameters with respect to an internal stimulus.

When two types of emotional motives occur simultaneously, an emotional motive resulting from a need-based need parameter has priority over an emotional motive resulting from an emotion parameter based on the external state of the intelligent robot. In determining an emotion parameter based on the state information of the intelligent robot, occurring motives are processed according to the priority of the occurrence.

As illustrated in FIG. 3, in order to determine a need-based emotional motive, the emotion motive determiner 300 is maintained within an equilibrium range 330 where a satisfaction level for a change in emotion need parameters 301 with time from stimulus information for a battery sensor and a temperature sensor, which is received from the state information collector 200, is in an stable emotion need state.

If the satisfaction level for the emotion need parameters 301 is lower than an equilibrium base point 302 or higher than an equilibrium limit point 303, that is, if the satisfaction level is within an activation region 310 and an activation region 330, an emotional need motive is activated and transmitted to the emotion state manager 400. In terms of Maslow's Hierarchy Of Needs, the emotion need parameters 301 are constituted by a 5-step layer including physiological needs, safety needs, love and belongingness needs, esteem needs, and self-actualization needs. In the present embodiment, emotion need parameters are defined on the basis of physiological needs, safety needs, and love and belongingness needs. Examples of emotion need parameters for physiological needs are hungriness, sleepiness, coldness, hotness, and thirstiness. Examples of emotion need parameters for safety needs are self-protection parameters for coping with conditions that are regarded as threat stimuli. Examples of emotion need parameters love and belongingness needs are: curiosity for expressing interest for strange things and persons; and loneliness that may arise when there is no change and stimulus during a predetermined time period. The emotion motive determiner 300 uses such parameters to generate emotional need motives.

So that each of the emotion need parameters 301 can maintain the equilibrium range 320 of an emotion in the activation regions 310 and 330 of an emotional need motive, the emotion motive determiner 300 satisfies emotional need motives while changing a satisfaction level 304 through expression of emotions and emotional actions. For example, for external state information such as “strike”, “stroke”, “tickle”, and “embrace”, an emotional motive is determined when a stimulus occurs through an emotion parameter.

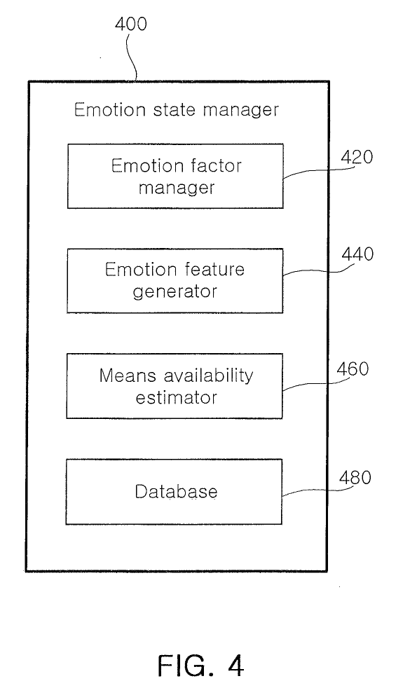

FIG. 4 is a detailed block diagram of the emotion state manager 400 of FIG. 1 according to an embodiment of the present invention.

Referring to FIG. 4, the emotion state manager 400 includes an emotion factor manager 420, an emotion feature generator 440, a means availability estimator 460, and a database 480.

The emotion factor manager 420 stores and manages, in the database 480, information that is generated according to an operation of the apparatus for expressing emotions in the intelligent robot.

In detail, the emotion factor manager 420 stores and manages the state information of the intelligent robot that is generated by merging the internal/external sensed information at the state information collector 200 in a hierarchical structure. In addition, the emotion factor manager 420 stores and manages occurrence time information for internal/external stimuli, “Daily Rhythm” information, and internal state information for the emotion of the intelligent robot that the emotion motive determiner 300 determines on the basis of the state and need of the intelligent robot by using information received from the state information collector 200. The emotion factor manager 420 stores and manages emotion information, which is newly generated by the emotion generator 500 with an initial emotion state of the intelligent robot set to a neutral emotion state, and current action information that is used by the action expresser 700 so as to finally express a corresponding emotion.

Based on the external sate information of the intelligent robot received from the state information collector 200, the emotion state information, and the emotion motive information received from the emotion motive determiner 300, the emotion factor manager 420 reflects the previous emotional state to generate emotional features with respect to the emotion model axis (Pleasantness, Activation, Certainty) of the three-dimensional emotion vector space. In addition, using input information, the emotion factor manager 420 manages factors for calculation of a vector on the emotion vector space in an emotion factor table of “Time”, “Happy”, “Unhappy”, “Arousal” and “Asleep” that are predefined.

For example, when the sensor information is analyzed as the “Stroke” state information of the intelligent robot, it is managed as the features of “Stimulus Time” and “Happy”. Information such as “Strike”, “hungry” and “Cold” is managed as an “Unhappy” factor.

Among the “Daily Rhythm” information, daytime-related information, such as “Morning” and “Afternoon”, and self-protection needs due to dangerous conditions are manages as an “Arousal” factor. That is, the external stimulus information is pre-classified and used as emotion feature information for determination of an emotion vector.

Using emotion factors managed by the emotion factor manager 420, the emotion feature generator 440 calculates emotion feature values so as to determine an emotion from an emotion model. The emotion feature generator 440 may be implemented in a module type. In the present embodiment, the emotion model is implemented using a “Takanishi's model that is a vector space including “Pleasantness”, “Activation”, and “Certainty”. Accordingly, a calculated emotion feature value corresponds to a vector [E=(Eₚ,E_{A},E_{c})].

For calculation of emotion feature values in the emotion feature generator 440, the emotion factor manager 420 manages state information (which is received from the state information collector 200) using the emotion factor table where the external state information and the internal state information (which can be emotion factors in the system) is pre-classified into “Time”, “Happy”, “Unhappy”, “Arousal”, and “Asleep”.

In addition, the emotion factor manager 420 analyzes the cause of occurrence of state information to determine whether the state information is active or passive. The active state information is generated by the action of the intelligent robot for expressing of an emotion, which is not used in calculating an emotion feature. For example, in the condition “I feel hot and hungry, but someone is embracing me and I am closing my eyes with my head leaned” of the intelligent robot, “with my head leaned” is an action that the intelligent robot takes for expression of an emotion. “Touch” action information is the state information of an active reaction to the above action.

The reason for the possibility of the above method is that the external state information and the internal state information are defined and restricted in advance.

A method of calculating an emotion feature value for generation of an emotion will now be described in detail.

Pleasantness Eₚ can be calculated as Equation (1) below. The resulting value of pleasantness Eₚ is in the range of [−1,1]. As the resulting value approaches “1”, the pleasantness increases.

$${E}_{p} = \frac{2 {N}_{p}}{{N}_{p} + {N}_{s}} - 1 \\ {N}_{p} = \frac{{\sum }_{i = 1}^{n} {w}_{i}^{p}}{n} \\ {N}_{u} = \frac{{\sum }_{i = 1}^{m} {w}_{i}^{u}}{m} \qquad ( 1 )$$

where P={w₁^{p}, w₂^{p}, . . . , wₙ^{p}}, U={w₁^{u}, w₂^{u}, . . . , wₙ^{u}} is a set of weights of emotion factors that are contained in “Happy” and “Unhappy” that have passive state information, wᵢ^{p} is the weight of the i^{th} emotion factor contained in “Happy”, n is the number of emotion factors contained in “Happy”, m is the number of emotion factors contained in “Unhappy”, Nₚ is the average of weights of emotional features contained in “Happy”, and Nᵤ is the average of weights of emotional features contained in “Unhappy”.

In the present embodiment, the emotion feature generator 440 has a value of “1.0” for the weight of an emotion factor at the time of occurrence and reduces the value by a predetermined amount per predetermined time. For calculation of the weight, the predetermined time and the predetermined amount are defined in advance.

For example, if the weight is reduced by 0.03 per second, when someone embraces me and then strikes me after three seconds, the weight of “embraces” is “1−0.09=0.91” and the weight of “strikes” is “1.0”.

Accordingly, Nₚ is “10.91” and Nᵤ is “1.0”. Therefore, Eₚ is “0.06”.

The means availability estimator 460 predefines and manages actuator information for each part of the intelligent robot that is suitable for expressing an emotion that is generated to satisfy an emotion motive that is determined by the emotion motive determiner 300. In addition, the means availability estimator 460 determines if a selected action is available. If the selected action is available, the means availability estimator 460 provides action information for expression of the current emotion. If the selected action is unavailable, the means availability estimator 460 again searches a suitable alternative expression means, estimates the availability thereof, and provides a factor for determining an action of the intelligent robot. That is, the means availability estimator 460 searches an action suitable for a generated emotion, determines the availability thereof, and provides a suitable expression means.

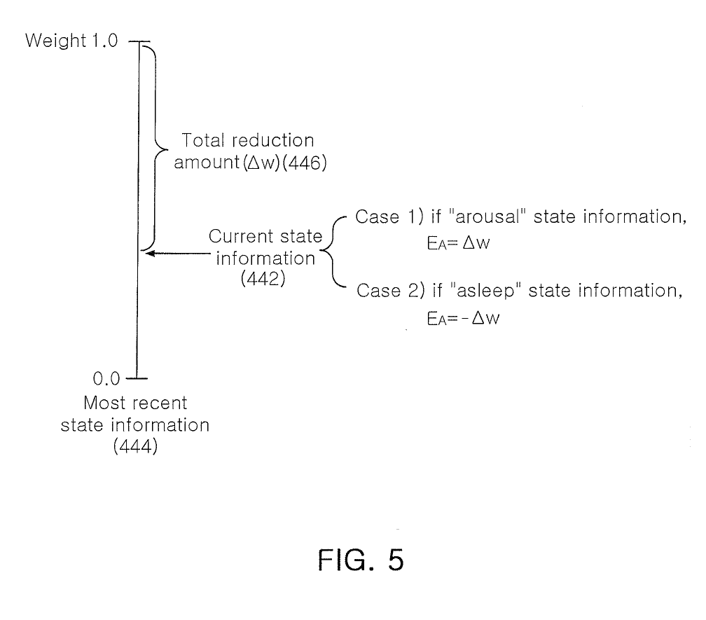

FIG. 5 is a diagram illustrating an example of a method for calculating, at the emotion feature generator 440, an active emotion feature value “Actuation E_{A}” using the weight of a state item that is an emotion factor that varies with a predetermined time.

Referring to FIG. 5, the active emotion feature value “Actuation E_{A}” is a scale for indicating an abrupt state change. When some state information 442 occurs, the emotion feature generator 440 calculates the active emotion feature value “Actuation E_{A}” using the total reduction amount Δw 446 of the weight for the most recent state information 444.

The active emotion feature value “Actuation E_{A}” is in the range of [−1,1]. As the active emotion feature value “Actuation E_{A}” approaches “1”, “arousal” increases. For example, if the weight is reduced by “0.03” per second, when the “strikes” state information occurs after twenty seconds from the occurrence of the “embraces” state information, the total reduction amount Δw is “0.6” and E_{A} is “0.6” because the “strikes” state belongs to the “arousal” state.

A certainty emotion feature value “Certainty E_{c}” is a scale for indicating the certainty of external state information, which is the very value that calculated by the state information collector 200. In the case of a need motive that is internal state information determined by the emotion motive determiner 300, the largest certainty value is used as a certain feature value. In the present invention, the certainty emotion feature value “Certainty E_{c}” is in the range of [−1,1]. As the certainty emotion feature value “Certainty E_{c}” approaches “1”, the certainty increases.

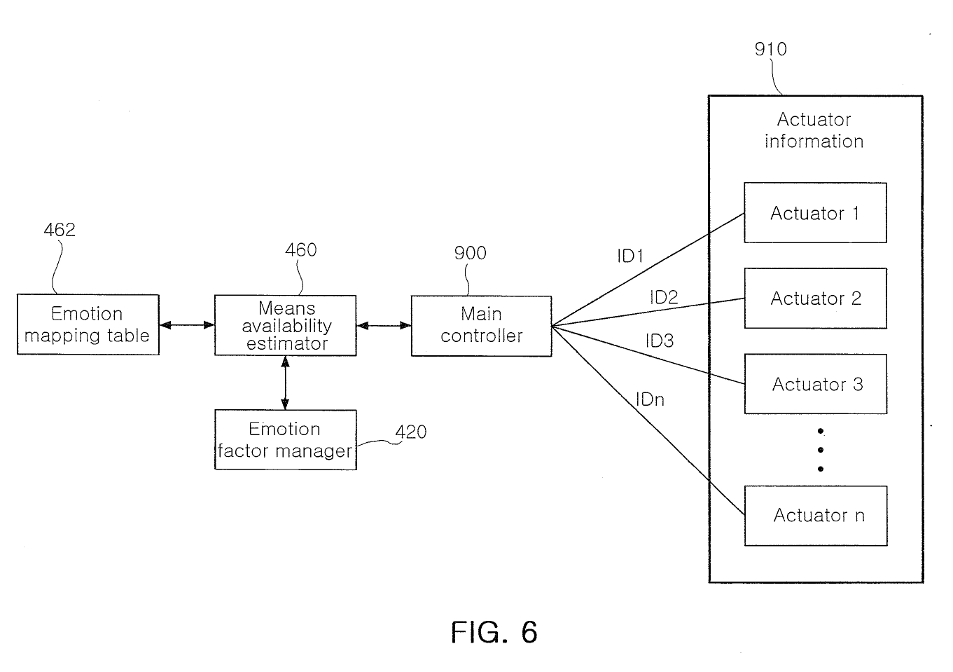

FIG. 6 is a diagram illustrating a process for estimating, at the means availability estimator 460, the availability of a means that is available as a decision model for a means for satisfying a motive, according to an embodiment of the present invention.

Referring to FIG. 6, the means availability estimator 460 searches a means that is most suitable for satisfying an emotion motive received from the emotion motive determiner 300, estimates the availability of the best suitable means, and provides the suitable information. The means availability estimator 460 may be implemented in a module type. A method for processing the availability estimation will now be described in detail.

Using an emotion mapping table 462 for pre-classified emotions, the means availability estimator 460 searches actuator information that is expressible for a generated emotion. The means availability estimator 460 provides the searched actuator information to a main controller 900 of the intelligent robot, for estimation of the availability of an action for the searched actuator information. Upon receipt of the searched actuator information from the means availability estimator 460, the main controller 900 detects an ID of actuator information 910 to determine the availability of the actuator information that is output from the means availability estimator 460. If the actuator information is available, the means availability estimator 460 provides the emotion generator 500 and the action determiner 600 with the corresponding actuator information as a factor for determining an action.

If the actuator information is unavailable, the means availability estimator 460 searches information about an alternative means and estimates the availability of the alternative means to search suitable actuator information.

In addition, using the sensed information for each part of the intelligent robot that is received from the state information collector 200 and is managed by the emotion factor manager 420, the means availability estimator 460 may indirectly determine the part information used by the intelligent robot to estimate the availability of the corresponding action.

For example, the parts of the intelligent robot, which are mainly used for expressing a “fear” emotion, are a face, a neck and arms. In the case of eyes, eyebrows and a mouth among the face portions, actuator information and robot portions suitable for the “fear” emotion are searched and an ID of each actuator is used to determine the availability thereof. In addition, the means availability estimator 460 may determine information about an actuator of a specific part of the intelligent robot by using the internal/external sensors' information such as touch, vision, audition, and smell, which are attached to the parts of the intelligent robot, such as head, back, nose, eye, hand and tail.

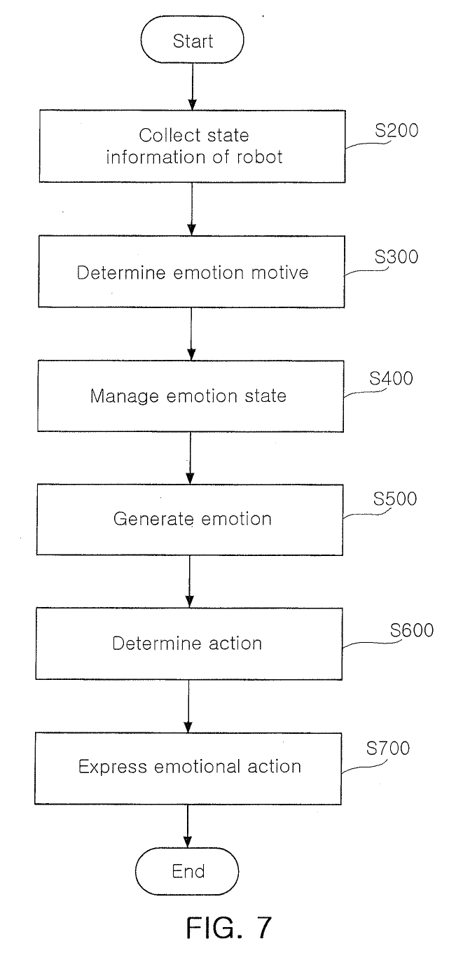

FIG. 7 is a flowchart illustrating a method for generating and expressing emotions on the basis of information about the internal/external stimuli of in the intelligent robot according to an embodiment of the present invention.

Referring to FIG. 7, the state information collector 200 collects the state information of the intelligent robot on the basis of information sensed by the internal/external sensors 120 and 160 in a sensor merging scheme with a hierarchical structure (S200).

When a need parameter is included in the activation regions 310 and 330 that is located outside a region between the equilibrium base point 302 and the equilibrium limit point 303 as a result of the degree of a change in the need parameter through the need-based emotion motive model, the emotion motive determiner 300 determines an emotional motive on the basis of the need parameter (S300).

The emotion state manger 400 stores the external state information of the intelligent robot in an emotion factor table using the emotion factor manager 420 and generates the internal state information of an emotion (S400). The emotion state manager 400 stores and manages input data, an emotion state, emotion action information, and daily rhythm information. In addition, the emotion state manager 400 generates emotion feature information using emotion factor data, and estimates the availability of a means for satisfying a generated emotion motive, to manage the entire emotions of the intelligent robot.

The emotion generator 500 generates emotion feature information, i.e., the value of a feature axis (Pleasantness, Activation, Certainty) on the three-dimensional space, thereby generating emotions such as sorrow, pleasure, fear, dislike, shame, and surprise through estimation of an emotion model (S500). The emotion state manager 400 stores and manages the emotion information, which is generated by the emotion generator 500, as state management information.

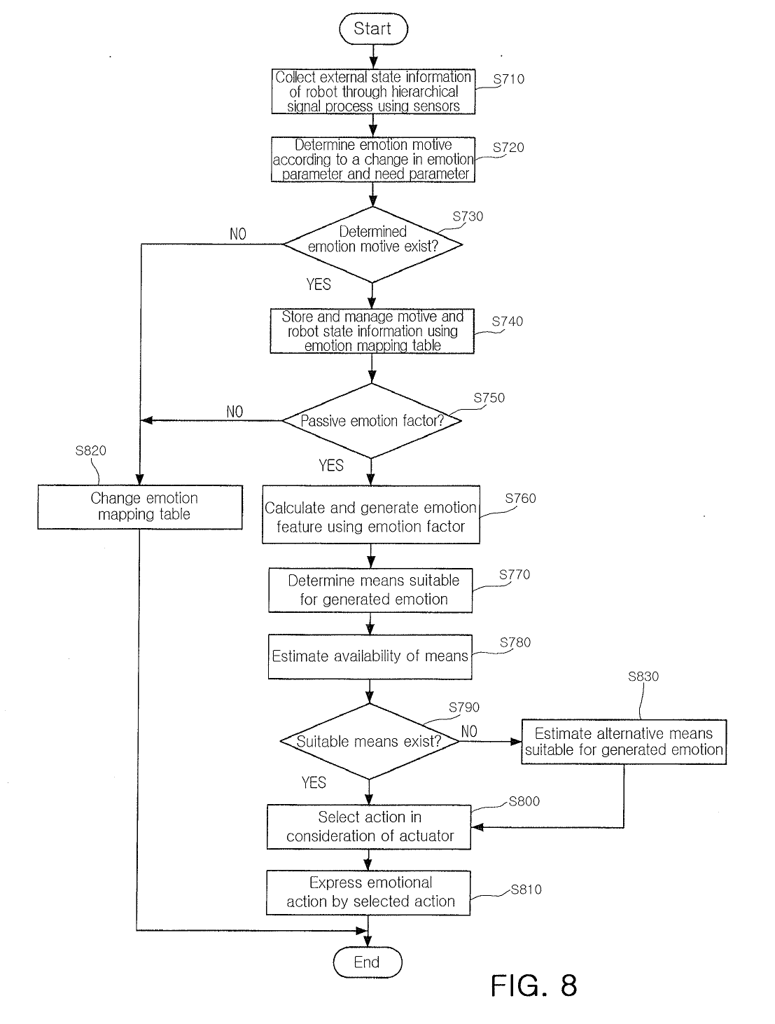

FIG. 8 is a flowchart illustrating in detail the emotion estimation, the emotion generation and the emotional action expression using the state information of the intelligent robot that is generated in response to the external/internal stimuli as illustrated in FIG. 7.

Using the hierarchical signal process scheme illustrated in FIG. 2, the state information collector 200 collects the external state information of the intelligent robot with respect to information that is sensed by the sensors 160 attached to the parts of the intelligent robot (S710).

The emotion motive determiner 300 determines an emotion motive, which is the internal state information, on the basis of the external state information collected by the state information collector 200 and the emotion/need parameters 301 (see FIG. 3) changed due to internal stimuli (S720).

The emotion state manager 400 determines the existence of the emotion motive that is determined by the emotion motive determiner 300 (S730). If there is no emotion motive determined, the emotion state manager 400 determines the external state information to be external sensor information that does not affect the emotion/need parameters to change and store the emotion mapping table 462, and then stops the process (S820).

If there is any emotion motive determined, the emotion state manager 400 generates and manages an emotion factor with respect to external state information and emotion motive information on the basis of the emotion mapping table. In addition, the emotion state manager 400 determines if the generated emotion factor is active or passive (S750).

If the generated emotion factor is determined to be active, the emotion state manager 400 changes information of the emotion mapping table (S820). If the generated emotion factor is determined to be passive, the emotion state manager 400 calculates an emotion feature value (Pleasantness, Activation, Certainty) on the basis of the generated emotion factor to generate a corresponding emotion (S760).

The emotion state manager 400 determines a suitable means for the generated emotion using the predefined emotion mapping table 462 (S770). The emotion state manager 400 estimates the availability of an actuator corresponding to the determined means (S780). The emotion state manager 400 determines the existence of a means that is suitable for performing the determined means (S790).

If there is no means that is suitable for performing the determined means, the emotion state manager 400 again detects the availability of an actuator that is currently available in the intelligent robot, to estimate an alternative means that is suitable for the generated emotion (S830).

If there is a corresponding means that is suitable for performing the means that is determined and estimated in steps 790 and 803, the action determiner 600 selects a corresponding action in consideration of the actuator that is suitable for expression of an emotion (S800). The action expresser 700 expresses the selected action in the intelligent robot, thereby expressing a variety of actions (S810).

As set forth above, according to certain or exemplary embodiments of the invention, a variety of sensors are attached to the corresponding parts of the intelligent robot and sensor values are processed in a hierarchical structure to obtain a variety of external state information, which cannot be obtained from a single sensor, thereby making it possible to predict the accurate state of the intelligent robot. In addition, an emotion is calculated using a weight change in state information with time, thereby making it possible to generate a new emotion in an indirect consideration of the previously-generated emotion. This enables the intelligent robot to express an emotion action related with the previous action, thereby making it possible to express an emotion more accurately and naturally.

Furthermore, the need-based emotion motive is generated according to a change in the time and the state information of the intelligent robot. Accordingly, it possible to generate a flexible motive that is suitable for the current state. In addition, an emotion is generated using the emotion state information (external state information, emotional states, and emotional need motive) of the intelligent robot and the most suitable action, which is generated through estimation of the availability of a means that is currently supportable by the intelligent robot as a means for expressing an emotion for satisfaction of a motive, is expressed using an actuator. Accordingly, it is possible to generate and express a variety of emotions using the intelligent robot.

While the present invention has been shown and described in connection with the preferred embodiments, it will be apparent to those skilled in the art that modifications and variations can be made without departing from the spirit and scope of the invention as defined by the appended claims.

What is claimed is:

1. An apparatus for expressing emotions in an intelligent robot, comprising:
a plurality of different sensors for sensing information about internal/external stimuli;
a state information collector for processing the sensed information about the internal/external stimuli in a hierarchical structure to collect external state information;
an emotion motive determiner for determining an emotion need motive in accordance with degree of a change in an emotion need parameter of internal state information on the basis of the external state information;
an emotion state manager for extracting available means information for satisfaction of the determined emotion need motive and state information corresponding to the available means information;
an emotion generator for generating emotion information on the basis of a feature value of the extracted state information;
an action determiner for determining action information for satisfaction of the emotion need motive on the basis of the extracted state information and the generated emotion information; and
an action expresser for expressing an action corresponding to the action information through a corresponding actuator on the basis of the determined action information.

2. The apparatus according to claim 1, wherein the state information collector comprises:
at least one first-order state node disposed in a first-order state layer of the hierarchical structure, the first-order state node merging desired informations out of internal/external stimulus information to extract one or more first-order state item.

3. The apparatus according to claim 2, wherein the state information collector comprises:
at least one second-order state node disposed in a second-order state layer higher than the first-order state layer, the second-order state node merging the first-order state items from the first-order state node to extract a second-order state item.

4. The apparatus according to claim 3, wherein the sate layers are provided in the structure of two or more layer and each of the state layers comprises:
at least one state node for merging n^{th}-order state items from state nodes of a lower state layer to extract (n+1)^{th}-order state items.

5. The apparatus according to claim 1, wherein the emotion motive determiner determines an emotion motive in accordance with the degree of a change in an emotion parameter on the basis of the external state information sensed by the different sensors, and determines the emotion need motive in accordance with the degree of a change in a needs-based need parameter on the basis of the internal state information.

6. The apparatus according to claim 5, wherein, during the determining of the needs-based emotion need motive, the emotion motive determiner maintains a current state within an equilibrium range of an emotion whose satisfaction level is stabilized on the basis of an equilibrium point using the need-based need parameter and, if the satisfaction level deviates from the equilibrium range, activates the emotion need motive in accordance with the change degree.

7. The apparatus according to claim 6, wherein, during the generating of the emotion motive in accordance with the change of the emotion parameter and the need parameter, the need parameter based emotions are generated in the priority order of physiological needs, safety needs, and belongingness needs, and the emotion parameter based emotions are generated sequentially and repeatedly in a predetermined priority order.

8. The apparatus according to claim 1, wherein the emotion state manager comprises:
an emotion factor manager for generating and managing emotion factors with respect to the external state information collected by the state information collector and the emotion need motive information determined by the emotion motive determiner, by using a preset emotion mapping table;
an emotion feature generator for generating an emotion feature value for determination of an emotion for the external state information and the emotion need motive information on the basis of the generated emotion factor; and
a means availability estimator for estimating the availability of a means for satisfaction of the emotion motive determined by the emotion motive determiner on the basis of the emotion feature value to extract available means information for satisfaction of the emotion need motive and state information corresponding to the available means information.

9. The apparatus according to claim 8, wherein the emotion factor manager stores and manages the internal/external state information sensed by the different sensors, the emotion information generated by the emotion generator, and information about an action taken by the action expresser.

10. The apparatus according to claim 8, wherein the emotion factor manager calculates an emotion vector for an emotion model axis on a three-dimensional emotion vector space while changing the weight for state information of an emotion factor according to a predetermined time on the basis of the external state information, the emotion motive information and the emotion state information.

11. The apparatus according to claim 10, wherein the emotion model axis comprises an emotion model including Pleasantness, Activation and Certainty.

12. The apparatus according to claim 11, wherein the emotion mapping table comprises at least one of Time, Happy, Unhappy, Arousal, and Asleep that are predefined for calculation of a vector on the emotion vector space.

13. The apparatus according to claim 11, wherein, if the emotion model axis is Pleasantness, the emotion factor manager uses the weighted sum of emotion factors contained in Happy and Unhappy having passive state information, has the maximum value at the time of occurrence of an emotion factor, and calculates an emotion vector while reducing the value by a predetermined amount per predetermined time.

14. The apparatus according to claim 11, wherein, if the emotion model axis is Activation, the emotion factor manager calculates an emotion feature for Activation corresponding to a scale for indicating an abrupt state change, on the basis of the total reduction amount of the weight for the most recent state information out of generated state information.

15. The apparatus according to claim 11, wherein, if the emotion model axis is Certainty, the emotion factor manager calculates a certainty feature value corresponding to a scale for the certainty of the state information of the intelligent robot by using a certainty degree calculated by the state information collector in the case of the external state information or by using the largest certainty feature value as a certainty degree in the case of the internal state information determined by the emotion motive determiner.

16. A method for expressing emotions in an intelligent robot, comprising:
sensing information about internal/external stimuli using a plurality of sensors;
processing the sensed information about the internal/external stimuli in a hierarchical structure to collect external state information;
determining an emotion need motive in accordance with the degree of a change in an emotion need parameter corresponding to internal state information on the basis of the external state information;
extracting available means information for satisfaction of the generated emotion need motive and state information corresponding to the available means information;
generating emotion information on the basis of a feature value of the extracted state information;
determining action information for satisfaction of the emotion need motive on the basis of the extracted state information and the generated emotion information; and
expressing an action corresponding to the action information through a corresponding actuator on the basis of the determined action information.

17. The method according to claim 16, wherein the collecting of the state information comprises:
merging, in a first-order state layer of the hierarchical structure, desired information out of internal/external stimulus information to extract one or more first-order state item; and
merging, in a second-order state layer higher than the first-order state layer, the extracted second-order state items to extract at least one second-order state item.

18. The method according to claim 17, wherein the determining of the emotion motive comprises:
determining an emotion motive in accordance with the degree of a change in an emotion parameter on the basis of the sensed external state information; and
determining the emotion need motive in accordance with the degree of a change in a need-based need parameter on the basis of the internal state information.

19. The method according to claim 18, wherein, during the determining of the need-based emotion need motive, the determining of the emotion motive is characterizing that a current state is maintained within an equilibrium range of an emotion whose satisfaction level is stabilized on the basis of an equilibrium point using the need-based need parameter and, if the satisfaction level deviates from the equilibrium range, the emotion need motive is activated in accordance with the change degree.

20. The method according to claim 16, wherein the extracting of the available means and the state information comprises:
generating and managing emotion factors with respect to the collected external state information and the determined emotion need motive information by using a preset emotion mapping table;
generating an emotion feature value for determination of an emotion for the external state information and the emotion need motive information on the basis of the generated emotion factor; and
estimating the availability of a means for satisfaction of the determined emotion motive on the basis of the emotion feature value to extract available means information for satisfaction of the emotion need motive and state information corresponding to the available means information.
